(19) United States
(12) Patent Application Publication
(10) Pub. No.: US 2004/0167824 A1
(43) Pub. Date: Aug. 26, 2004

(54) Match-and-swap marketplace

(75) Inventors: Vinayek K. Singh, Litchfield, CT (US); Marshall G. Flax, Merrick, NY (US); Gurdeep S. Malik, Fortlee, NJ (US)

Correspondence Address: VENABLE, BAETJER, HOWARD AND CIVILETTI, LLP, P.O. BOX 34385, WASHINGTON, DC, 20043-9998, US

(73) Assignee: Tullett Liberty Inc., New York, NY (US)

(21) Appl. No.: 10/678,376

(22) Filed: Oct. 6, 2003

Related U.S. Application Data
(63) Continuation-in-part of application No. 10/372,409, filed on Feb. 25, 2003, now abandoned.

(51) Int. Cl. G06F 17/60

(52) U.S. Cl. 705/26

(57) ABSTRACT

A number of orders are received from a number of participants to buy and/or sell a number of products. Each order is a unilateral order from one of the participants and identifies a number of units of one of the products to buy or sell. Swap prices are set for the products. The units of the orders are matched based on constrained net activity for the participants and the products to maximize a number of units matched to obtain matched orders and unmatched orders. The matching is independent of the swap prices.

### CROSS-REFERENCE TO RELATED APPLICATIONS

This application claims the priority of U.S. patent application Ser. No. 10/372,409, filed Feb. 25, 2003 (Attorney Docket No. 32894-180460), which is incorporated herein by reference.

### BACKGROUND OF THE INVENTION

1. Field of the Invention

The present invention relates generally to a network-based marketplace, and more particularly to a network-based marketplace for exchanging products.

2. Related Art

Conventionally, products are exchanged based on price, and monetary consideration is given to receive a product based on a price of the product. A buyer and a seller agree on a price, and the product and monetary consideration are exchanged between the buyer and the seller.

In some situations, however, a seller may be more interested in adjusting the composition of inventory than in receiving monetary consideration for products in the inventory. In such a situation, the seller is willing to receive other products in exchange for the products in the seller's inventory. Such a transaction is known as a bartered transaction, and no monetary consideration is exchanged.

To barter, a party determines a bilateral order. The bilateral order identifies a number of units of a first product (i.e., units owned) to exchange for a number of units of a second product (i.e., units to acquire). To conduct a bartered transaction, the party must locate another party with whom to barter, which is known as bilateral bartering. Such a search may be difficult, time consuming, and inefficient.

If many parties desire to conduct bartered transactions, a marketplace can exist. Such marketplaces, however, are difficult to establish, and once established, conducting transactions can be time consuming and expensive for all parties. In such a marketplace, multiple parties having bilateral orders can exchange products in a single transaction, known as multilateral bartering. Multilateral bartering, however, is difficult to organize and can be inefficient.

There exists a need for an efficient marketplace to conduct barter-type exchanges among multiple parties.

### SUMMARY OF THE INVENTION

In an exemplary embodiment of the invention, a match-and-swap marketplace is provided for the efficient undertaking of barter-type exchanges between a multiple parties.

The method of the invention includes a method for matching orders comprising the steps of: receiving a plurality of orders from a plurality of participants to buy and/or sell a plurality of products, each order being a unilateral order from one of the participants identifying a number of units of one of the products to buy or sell; setting swap prices for the products; and matching units of the orders based on constrained net activity for the participants and the products to maximize a number of units matched to obtain matched orders and unmatched orders, the matching independent of the swap prices.

The system of the invention includes a computer system including a computer-readable medium having software to operate a computer in accordance with the invention.

The apparatus of the invention includes a computer including a computer-readable medium having software to operate the computer in accordance with the invention.

The article of manufacture of the invention includes a computer-readable medium having software to operate a computer in accordance with the invention.

Further features and advantages of the invention, as well as the structure and operation of various embodiments of the invention, are described in detail below with reference to the accompanying drawings.

### Definitions

A “computer” refers to any apparatus that is capable of accepting a structured input, processing the structured input according to prescribed rules, and producing results of the processing as output. Examples of a computer include: a computer; a general purpose computer; a supercomputer; a mainframe; a super mini-computer; a mini-computer; a workstation; a micro-computer; a server; an interactive television; a hybrid combination of a computer and an interactive television; and application-specific hardware to emulate a computer and/or software. A computer can have a single processor or multiple processors, which can operate in parallel and/or not in parallel. A computer also refers to two or more computers connected together via a network for transmitting or receiving information between the computers. An example of such a computer includes a distributed computer system for processing information via computers linked by a network.

A “computer-readable medium” refers to any storage device used for storing data accessible by a computer. Examples of a computer-readable medium include: a magnetic hard disk; a floppy disk; an optical disk, such as a CD-ROM and a DVD; a magnetic tape; a memory chip; and a carrier wave used to carry computer-readable electronic data, such as those used in transmitting and receiving e-mail or in accessing a network.

“Software” refers to prescribed rules to operate a computer. Examples of software include: software; code segments; instructions; computer programs; and programmed logic.

A “computer system” refers to a system having a computer, where the computer comprises a computer-readable medium embodying software to operate the computer.

A “network” refers to a number of computers and associated devices that are connected by communication facilities. A network involves permanent connections such as cables or temporary connections such as those made through telephone or other communication links. Examples of a network include: an internet, such as the Internet; an intranet; a local area network (LAN); a wide area network (WAN); and a combination of networks, such as an internet and an intranet.

### BRIEF DESCRIPTION OF THE DRAWINGS

The foregoing and other features and advantages of the invention will be apparent from the following, more particular description of a preferred embodiment of the invention, as illustrated in the accompanying drawings. The left most digits in the corresponding reference number indicate the drawing in which an element first appears.

FIG. 1 depicts a flowchart for a first embodiment of the invention.

FIG. 2 depicts a flowchart for a second embodiment of the invention.

FIG. 3 depicts a flowchart for a third embodiment of the invention.

FIG. 4 depicts a flowchart for a fourth embodiment of the invention.

FIG. 5A depicts an order matrix for a first example of the invention.

FIG. 5B depicts a matched matrix for the first example.

FIG. 5C depicts an unmatched matrix for the first example.

FIG. 5D depicts a priority matrix for the first example.

FIG. 5E depicts a matched matrix based on the priority matrix of FIG. 5D for the first example.

FIG. 5F depicts an unmatched matrix based on the matched matrix of FIG. 5E for the first example.

FIG. 6A depicts an order matrix for a second example of the invention.

FIG. 6B depicts a matched matrix for the second example.

FIG. 6C depicts a priority matrix for the second example.

FIG. 6D depicts a matched matrix based on the priority matrix of FIG. 6C for the second example.

FIG. 6E depicts an unmatched matrix based on the matched matrix of FIG. 6D for the second example.

FIG. 6F depicts an order matrix based on the unmatched matrix of FIG. 6E after a second order period for the second example.

FIG. 6G depicts a matched matrix based on the order matrix of FIG. 6F for the second example.

FIG. 7 depicts a flowchart for an exemplary matching for the first and second embodiments.

FIG. 8 depicts a flowchart for an exemplary matching for the third and fourth embodiments.

FIG. 9 depicts a flowchart for an alternative exemplary matching for the third and fourth embodiments.

FIG. 10 depicts a system perspective of the invention.

### DETAILED DESCRIPTION OF AN EXEMPLARY EMBODIMENTS OF THE INVENTION

A preferred exemplary embodiment of the invention is discussed in detail below. While specific exemplary embodiments are discussed, it should be understood that this is done for illustration purposes only. A person skilled in the relevant art will recognize that other components and configurations can be used without parting from the spirit and scope of the invention. The embodiments and examples discussed herein are non-limiting examples.

In the match-and-swap marketplace of the invention, a number of participants (i.e., sellers and buyers) desire to exchange units of various types of products. The participants are generally more concerned with exchanging inventory than with reducing and/or increasing inventory. By exchanging inventory, a participant can make the inventory more balanced, reduce odd-lot portions, and/or reduce odd-dated portions (e.g., odd-dated interest rate exposure). As such, in the match-and-swap marketplace of the invention, the price of each unit of each type of product is either the same or set by the administrator of the marketplace.

Examples of the types of products that can be used in the match-and-swap marketplace of the invention include the following: financial contracts, securities, money, commodities, products and/or services traditionally and not traditionally exchanged on an exchange, and any combination thereof.

Examples of the types of participants that can interact with the match-and-swap marketplace of the invention include the following: a person; a group of people; a business; an agent; a broker; a trader; a legal entity; trading or other subaccounts thereof; and any combination thereof.

Further, multiple participants can be assigned to the same entity. For example, an entity (e.g., a brokerage firm) controls products (e.g., financial contracts) for a number of customers and desires to participate in the match-and-swap marketplace on behalf of each customer. In this example, the entity is assigned a number of participants to interact with the marketplace. The entity has the option of lumping a number of its customers together as the same participant, aligning one customer to each participant, and any combination thereof. An entity may even use multiple participants on behalf of a single customer of the entity.

As another example, an entity may desire to participate with different products and/or product combinations in the match-and-swap marketplace. Once again, the entity is assigned a number of participants to interact with the marketplace. The entity can partition its products and/or product combinations in a desired manner and align the partitioned products and/or product combinations with the assigned participants.

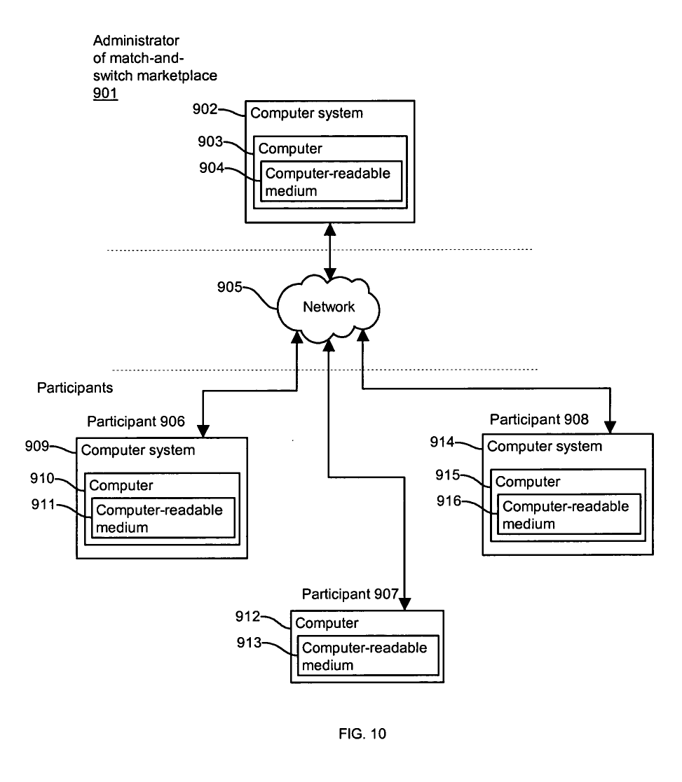

FIG. 10 illustrates a system perspective of the invention. In FIG. 10, an administrator 901 operates a match-and-swap marketplace according to the invention. The administrator 901 includes a computer system 902, which includes at least one computer 903 for implementing the invention. The computer 903 includes a computer-readable medium 904 embodying software for implementing the invention and/or software to operate the computer 903 in accordance with the invention. The computer system 902 includes a connection to a network 905. The network 905 is connected to a number of participants 906, 907, and 908. Although three participants are illustrated in FIG. 10, any number of participants can use the system of the invention and can communicate with the administrator 901. Further, one or more networks 905 can be used to connect the administrator 901 and the participants.

As an example, participant 906 includes a computer system 909 including a computer 910 for implementing the invention. The computer 910 includes a computer-readable medium 911 embodying software for implementing the invention and/or software to operate the computer 910 in accordance with the invention. The computer system 909 includes a connection to the network 905.

As another example, participant 907 includes a computer 912 for implementing the invention. The computer 912 includes a computer-readable medium 913 embodying software for implementing the invention and/or software to operate the computer 912 in accordance with the invention. The computer 912 includes a connection to the network 905.

As a further example, participant 908 includes a computer system 914 including a computer 915 for implementing the invention. The computer 915 includes a computer-readable medium 916 embodying software for implementing the invention and/or software to operate the computer 915 in accordance with the invention. The computer system 914 includes a connection to the network 905.

In FIG. 10, the three participants 906, 907, and 908 communicate individually with the administrator 901 through computers or computer systems. As an option, multiple participants can communicate with the administrator 901 through a single computer or computer system.

This option is useful to an entity that is assigned multiple participants to interact with the match- and-swap marketplace.

In operation, participants submit orders during an order period to the administrator 901 electronically via the network 905. Once the order period has expired, the administrator matches the orders to determine matched orders and unmatched orders, swaps matched orders, and notifies the participants electronically via the network 905 of the swapped orders and unmatched orders.

### First Embodiment and First Example

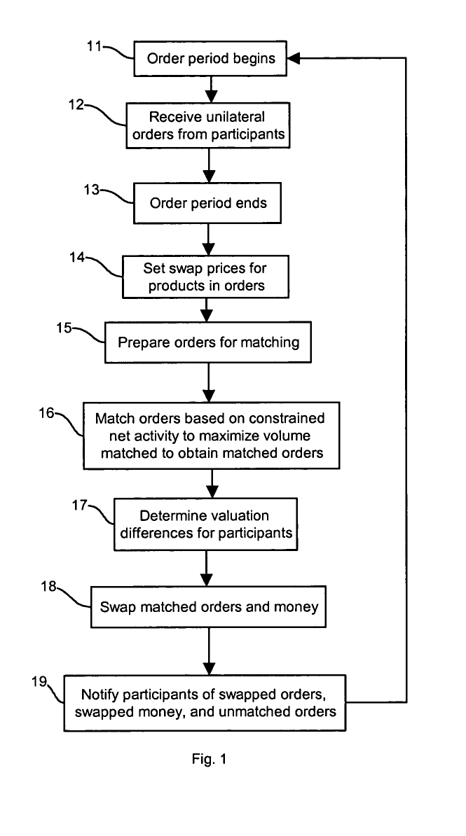

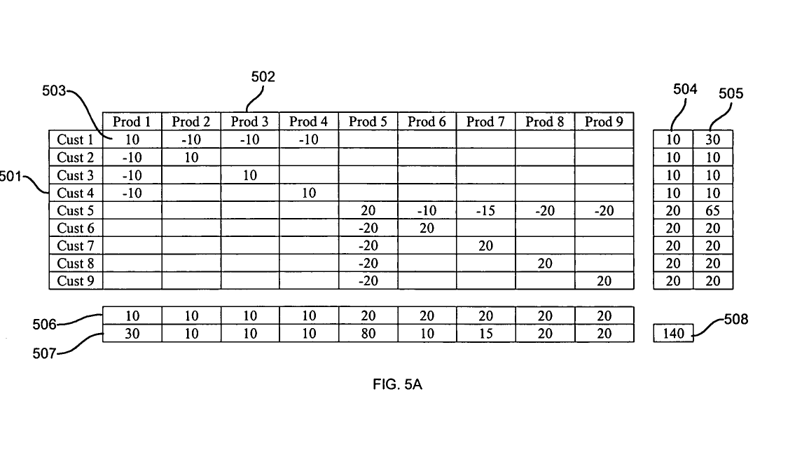

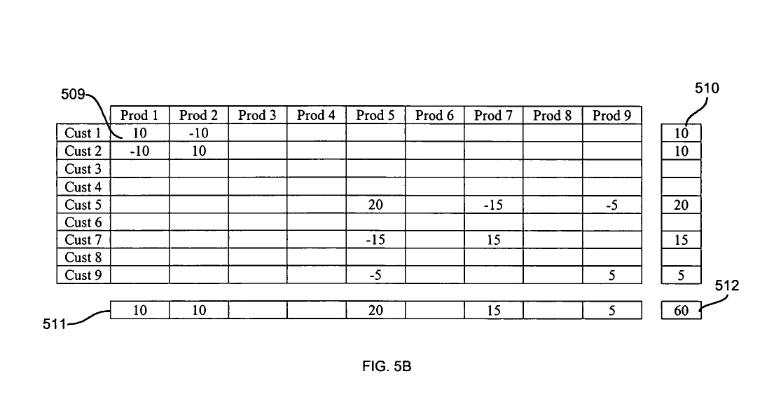

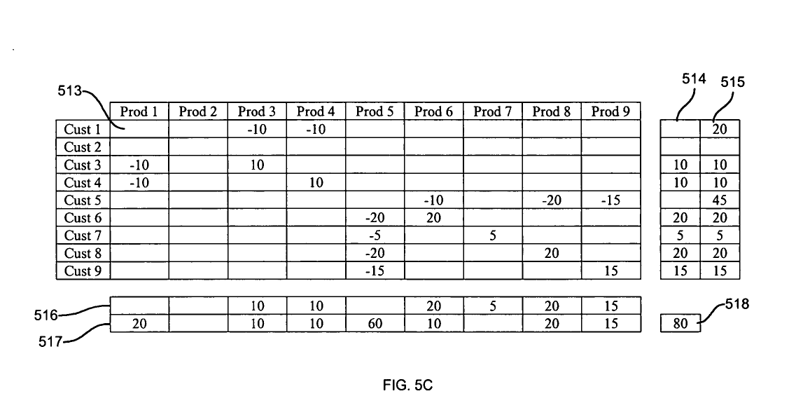

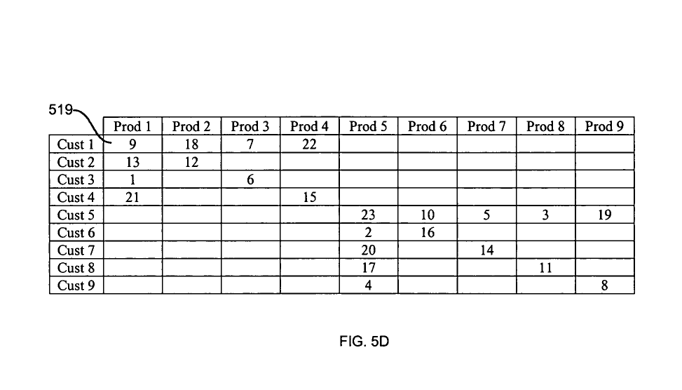

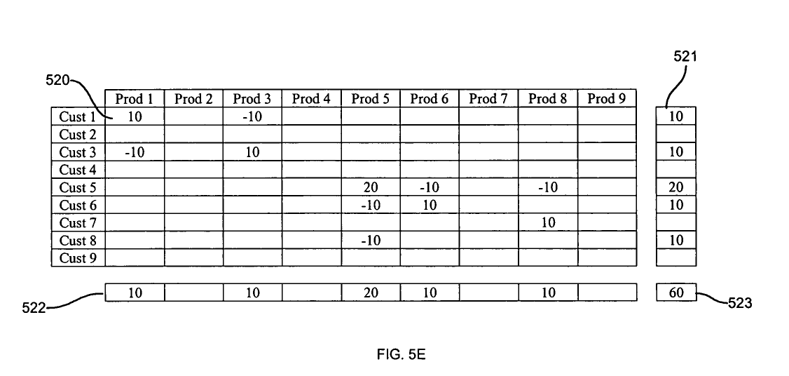

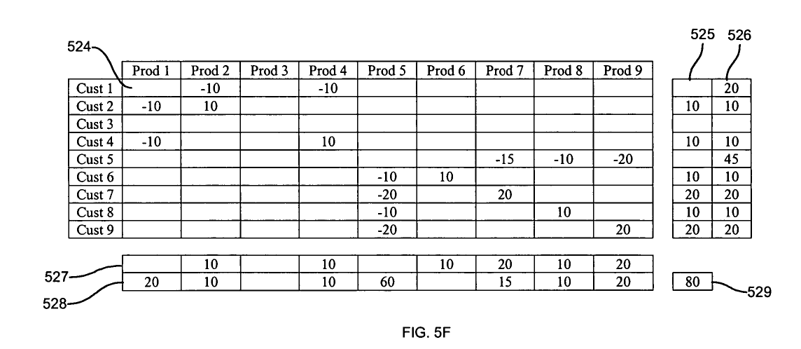

FIG. 1 illustrates a flowchart for a first embodiment of the invention. FIG. 1 is discussed with respect to a first example illustrated in FIGS. 5A, 5B, and 5C and with respect to FIG. 10.

In block 11 of FIG. 1, an order period begins for receiving unilateral orders. The administrator 901 determines the order period and opens the order period.

In block 12, the administrator 901 receives unilateral orders from participants. A unilateral order identifies a number of units of a product to buy or sell. The unilateral order of the invention is distinguished from the bilateral order in conventional barter systems. A bilateral order identifies a number of units of a first product to sell in exchange for a number of units of a second product to buy, whereas a unilateral order identifies a number of units of a single product to buy or sell.

A participant can place as many unilateral orders as desired and can accumulate a “bucket” of unilateral orders. The bucket of unilateral orders of the invention is distinguished from the bilateral order in conventional barter systems. A bilateral order identifies what units need to be exchanged for other units, whereas a bucket of unilateral orders lacks any designation as to what units need to be exchanged for other units. As an option, a participant can place a single bucket-type order comprising unilateral orders for all requests (or a subset thereof) of the participant to buy and/or sell all desired products (or a subset thereof).

If an entity desiring to interact with the match-and-swap marketplace has multiple products but does not want to lump all the products together, the entity is assigned multiple participants. For example, if the entity is interested in 5 products (e.g., A, B, C, D, and E products), the entity may have the following desires: (1) buying A or B products against selling C products; (2) buying D products against selling E products; and (3) not buying A or B products against selling E products. For this example, the entity is assigned two participants. The first participant places orders for A, B, and C products, and the second participant places orders for D and E products. The orders placed by these multiple participants may even overlap. For example, the first participant may enter orders for A, B, and C products, and the second participant may enter orders for C, D, and E products.

The number of units in the unilateral orders can be whole or fractional numbers.

The unilateral orders do not need to include prices to sell or buy the products because price is not used by the invention to match units of the unilateral orders.

The one or more products, or types of products, to be exchanged can be set by the administrator 901. As an option, the participants can determine the one or more products, or type of products, to be exchanged based on the unilateral orders placed.

To place a unilateral order, a participant informs the administrator 901 of the number of units of a product the participant desires to sell or buy. At any time during the order period, the participant can add to, delete, or modify the unilateral order. At any time during the order period, the participant can place additional unilateral orders.

The administrator 901 receives unilateral orders from the participants electronically via the network 905. Alternatively, the administrator 901 can receive unilateral orders via the telephone, telephonic communication techniques, data communication techniques, or other communication techniques.

In block 13, the order period ends. The administrator 901 closes the window for accepting unilateral orders from participants.

In block 14, the administrator 901 sets swap prices for the products identified in the unilateral orders received. To set the swap prices, the administrator 901 can use any pricing methodology. For example, the administrator 901 can set the swap prices based on: current or future market prices in the marketplace or in similar marketplaces; current or future input from a person or group of persons knowledgeable in the valuation of the products; a determination independent of the unilateral orders; one or more analytic methods to generate one or more financial models for setting current or future prices; a pricing methodology and/or criteria based on a future point in time, such as after matching; and/or a current pricing methodology and can be reset after matching. As an option, the administrator 901 can set the swap prices using different pricing methodologies and/or combinations of different pricing methodologies for different products. As an additional option, the administrator 901 can set the swap prices for all products that can be exchanged in the marketplace, and not just for the products for which unilateral orders were received.

As an option, after the administrator 901 sets the swap prices, a withdrawal period begins, and each participant can withdraw one, some, or all of the orders of the participant during the withdrawal period. If a participant disagrees with the swap prices or is unhappy with the swap prices, the withdrawal period provides the participant with an opportunity to withdraw any or all of the order(s) of the participant. As a further option, during the withdrawal period, the participants can be permitted to modify any or all of the order(s) and/or submit new order(s).

In block 15, the administrator 901 prepares the received orders for matching. For example, the administrator 901 can populate an order matrix. The order matrix is a matrix of size (c x m), where c is the number of participants submitting orders and m is the number of products (or markets) for which orders are received. Alternatively, c is the number of participants who have access to the administrator 901. As another alternative, m is the number of all products that can be exchanged in the marketplace. Each element of the order matrix identifies the number of units desired to be sold or bought by a particular participant for a particular product.

As an option, the administrator 901 can populate the order matrix during the order period as orders are received from participants, instead of waiting until the order period has expired.

FIG. 5A illustrates an exemplary order matrix for a first example of the invention. In the order matrix, the rows 501 correspond to the participants (nine participants here), and the columns 502 correspond to the products for which orders were received (nine products here). If a participant places an order to sell a number of units of a product, the corresponding entry in cell 503 of the order matrix is negative, and if a participant places an order to buy a number of units, the corresponding entry in cell 503 of the order matrix is positive. The cells with no orders are blank (i.e., zero units). To the right of the order matrix, column 504 identifies the total number of units that each participant ordered to buy, and column 505 identifies the total number of units that each participant ordered to sell. At the bottom of the order matrix, row 506 identifies the total number of units for each product for every participant that placed an order to buy the product, and row 507 identifies the total number of units for each product for every participant that placed an order to sell the product. At the bottom right, cell 508 identifies the minimum of either the total number of units that participants ordered to buy or the total number of units that participants ordered to sell.

In this example, participant 1 (the first row) placed orders to buy ten units of product 1 and sell ten units each of products 2, 3, and 4. Participant 1 ordered to buy a total of 10 units (column 504) and sell a total of 30 units (column 505). As another example, participant 2 (the second row) placed orders to sell 10 units of product 1 and buy 10 units of product 2. As a further example, participant 5 (the fifth row) placed orders to buy 20 units of product 5, sell 10 units of product 6, sell 15 units of product 9, sell 20 units of product 9, and sell 20 units of product 9. Participant 5 placed orders to buy a total of 20 units (column 504) and sell a total number of 65 units (column 505).

For product 1 (the first column), participant 1 placed an order to buy 10 units, and participants 2, 3, and 4 each placed an order to sell 10 units. In total for product 1, 10 units are ordered to be bought (row 506), and 30 units are ordered to be sold (row 507). For product 5, participant 5 placed an order to buy 20 units, and participants 6, 9, 8, and 9 each placed an order to sell 20 units. In total for product 5, 20 units are ordered to be bought (row 506) and 80 units are ordered to be sold (row 507). For all orders, 140 units (cell 508) is the minimum of either the total number of units that participants ordered to buy (140 here) or the total number of units that participants ordered to sell (205 here).

In block 16, the administrator 901 obtains matched orders and unmatched orders by matching units of orders based on constrained net activity for each participant and each product to maximize the number of units matched independent of the swap prices. The matched orders are a subset of the orders. Each matched order corresponds to an order and contains all or less than all of the units in the corresponding order. The unmatched orders are a subset of the orders. Each unmatched order corresponds to an order and contains all or less than all of the units in the corresponding order. If all units in an order are matched, the order becomes a matched order. If all units in an order are not matched, the order becomes an unmatched order. If some units in an order are matched and the remaining units in the order are not matched, the order is split into a matched order and an unmatched order.

In constraining net activity for each participant, the administrator 901 determines a matching such that the number of units bought by a participant is equal to the number of units sold by the participant. As an alternative, in constraining net activity for each participant, the administrator 901 determines a matching such that the weighted number of units bought by a participant is equal to the weighted number of units sold by the participant, where the weighting used is non-unitary (i.e., not all 1's). The weighting can be assigned by the administrator 901 using any available technique. For example, the weighting can be linear. As another example, the weighting can be based on the swap prices assigned to the products by the administrator 901 in block 14.

As a further constraint, the administrator 901 constrains the net activity for each product. In constraining net activity for each product, the administrator 901 determines a matching such that the number of units for a product to be bought is equal to the number of units for a product to be sold. As an alternative, in constraining net activity for each product, the administrator 901 determines a matching such that the weighted number of units for a product to be bought is equal to the weighted number of units for the product to be bought, where the weighting used is non-unitary. The weighting can be assigned by the administrator 901 using any available technique. For example, the weighting can be linear. As another example, the weighting can be based on the swap prices assigned to the products by the administrator 901 in block 14.

In maximizing the number of units matched, the administrator 901 determines a matching such that the total number of matched units bought and sold for all participants and for all products is maximized. The administrator 901 attempts to maximize the total quantity, or volume, matched. As an alternative, in maximizing the number of units matched, the administrator 901 determines a matching such that the total weighted number of matched units bought and sold for all participants and for all products is maximized, where the weighting used is non-unitary. The weighting can be assigned by the administrator 901 using any available technique. For example, the weighting can be linear. As another example, the weighting can be based on the swap prices assigned to the products by the administrator 901 in block 14.

In matching units, the matching is independent of the swap prices from block 14. The matching of the invention does not depend on the swap prices, or any other prices, for the products. Instead, the matching of the invention depends on the number of units in the unilateral orders and on the constrained net activity for each participant and each product. Although the constrained net activity can be weighted based on the swap prices, the swap prices themselves are not used to match units in the unilateral orders. The matching of the invention is distinguished from conventional matching which generally relies on prices to match orders.

In matching units, a valuation difference may exist between the number of units matched for each participant. The valuation difference may be due to the swap prices assigned in block 14 to each product not being equal, or to the weighting in the net activity constraint causing a participant to buy or sell different volumes. If a valuation difference exists, the value of matched units to be bought by a participant may not be the same as the value of matched units to be sold by the participant. In maximizing the number of units matched, the valuation differences can be minimized.

The administrator 901 can additionally determine a matching such that the total weighted number of matched units bought and sold for all participants and for all products is maximized, where the weighting used is non-unitary, and where a valuation difference between the number of units matched for each participant is minimized. The weighting can be assigned by the administrator 901 using any available technique. For example, the weighting can be linear. As another example, the weighting can be based on the swap prices assigned to the products by the administrator 901 in block 14. One technique to minimize the valuation differences is to set the net activity weights close to the swap prices for the products. If the swap prices are reset or reevaluated after the matching, a market shift in prices may occur during the withdrawal period and the matching. If such a market shift occurs, additional valuation differences may be incurred.

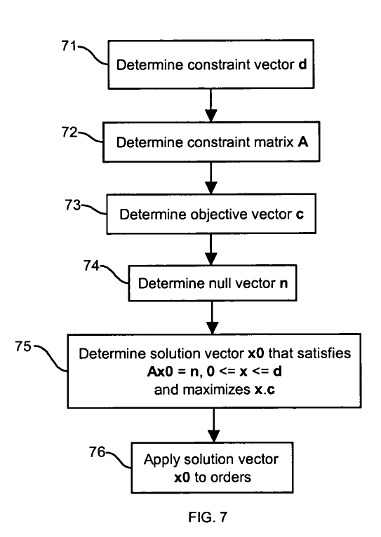

Several techniques are available to determine how to match units desired to be sold with units desired to be bought. Examples of such techniques that find an optimal solution include: linear programming; quadratic (or higher) programming; linear programming to maximize a total quantity matched; quadratic programming to minimize an allocation variance with a linear programming constraint to maximize a total quantity matched; an iterative linear programming procedure in which allocations are made in strict priority while satisfying linear programming constraints to maximize a total quantity matched; and “greedy” algorithms. (A greedy algorithm begins with a random or arbitrary initial solution and thereafter repeatedly attempts localized improvements, which typically yield local maxima and not global maxima. The greedy algorithm can repeatedly scan for and apply possible matches until no more are possible.) One such exemplary matching is discussed below with reference to FIG. 7. Other techniques for matching units in the marketplace will be appreciated by those of ordinary skill in the technology.

As an example of this block, a matched matrix can be determined from the order matrix.

FIG. 5B illustrates a matched matrix for the order matrix of FIG. 5A. The matched matrix in FIG. 5B was determined via linear programming to maximize the total quantity matched. Each cell 509 in the matched matrix corresponds to the number of units matched for a corresponding participant and a corresponding product in the order matrix. Each entry for a cell in the matched matrix is less than or equal the entry in the corresponding cell in the order matrix. To the right of the matched matrix, column 510 provides the total number of units that can be swapped for each participant (i.e., the total number of units bought, or the total number of units sold). At the bottom of the matched matrix, row 511 provides the total number of units that can be swapped for each product. Column 510 and row 511 indicate the net activity number of units bought (or sold, since they are equal) and result from the constraint on the net activity for each participant. At the bottom right, cell 512 provides the total number of units that can be swapped due to the matching.

In this example, the administrator 901 determines that participant 1 will buy ten units of product 1, sell 10 units of product 2, but not sell any units of products 2 and 3. Participant 1 will swap 10 units (column 510). As another example, participant 5, as a result of the matching, will buy 20 units of product 5, sell 15 units of product 9, and only sell 5 units of product 9. Participant 5 will swap 20 units (column 510). Participant 5, however, will not sell any units of products 6 and 8 and will not sell the remaining 15 units of product 9.

For product 1, participant 1 will buy 10 units, and participant 2 will sell 10 units. A total of 10 units will be swapped for product 1 (row 511). For product 5, participant 5 will buy 20 units, participant 9 will sell 15 units, and participant 9 will sell 5 units. A total of 20 units will be swapped for product 5 (row 511). In total, 60 units will be swapped (cell 512).

As a constraint on the matching in this example, although a participant is permitted to submit orders totaling an unequal number of units to sell and to buy, the matching routine only matches an equal number of units to sell and to buy for each participant, where the units can be for a variety of different products. As a further constraint on the matching in this example, the matching routine only matches an equal number of units to sell and to buy for each product, where the units can be for a variety of different participants.

Moreover, due to the constraints under specifying a unique solution for the linear programming technique, more than one solution may exist. In other words, a unique matched matrix may not exist for the order matrix.

FIG. 5C illustrates an unmatched matrix based on the matched matrix from FIG. 5B and the order matrix of FIG. 5A. Each cell 513 in the unmatched matrix of FIG. 5C is obtained by subtracting the corresponding cell in the matched matrix of FIG. 5B from the corresponding cell in the order matrix of FIG. 5A. To the right of the unmatched matrix, column 514 identifies the total number of unmatched units that each participant placed an order to buy, and column 515 identifies the total number of unmatched units that each participant placed an order to sell. At the bottom of the unmatched matrix, row 516 identifies the total number of unmatched units for each product for which every participant placed an order to buy, and row 517 identifies the total number of unmatched units for each product for which every participant placed an order to sell. At the bottom right, cell 508 identifies the minimum of either the total number of unmatched units that participants desired to buy or the total number of unmatched units that participants desired to sell.

In block 17, the administrator 901 determines valuation differences for each participant. The administrator 901 determines values for the matched orders from block 16 based on the swap prices of the products determined in block 14 and determines the valuation difference for each participant based on these values. If the value of the matched units to be bought is greater than the value of the matched units to be sold for a participant, the participant has a negative valuation difference and needs to pay money to complete the transaction. If the value of the matched units to be bought is less than the value of the matched units to be sold for a participant, the participant has a positive valuation difference and needs to receive money to complete the transaction. If the value of the matched units to be bought is equal to the value of the matched units to be sold for a participant, the participant has a zero valuation difference and needs to neither pay nor receive money to complete the transaction. The sum of valuation differences for all participants is zero.

If the swap prices are reset and/or reevaluated prior to determining valuation differences, a market shift in prices may occur and can be accommodated in the valuation differences determined in block 17.

As an alternative, if all products have the same swap price, or value, from block 14, block 17 can be skipped.

As an option, if the administrator 901 charges a use fee, the use fee can be added to the valuation differences determined in block 17.

In block 18, the administrator 901 swaps matched orders per the matching determining in block 16 to obtain swapped orders and swaps money per the valuation differences in block 17 to obtain swapped money. The technique used to swap the matched units is based on the specifics of the types of products, the marketplace, and the administrator 901. For example, for financial products, the administrator 901 swaps the financial products based on techniques used in a financial marketplace. The technique used to swap the matched money is based on the specifics of the marketplace and the administrator 901. For example, to participate in the marketplace, a participant must maintain an account, or a line of credit, with the administrator 901 to pay and receive money for any valuation differences. As an alternate, instead of the administrator 901, a clearinghouse, or a similar entity, conducts the swapping of the units and/or money. As another alternate, instead of payment, margin account requirement adjustment or other accounting offsets may be applied.

In block 19, the administrator 901 notifies participants of the swapped orders, swapped money, and/or the unmatched orders. The administrator 901 can notify participants electronically via the network 905. Alternatively, the administrator 901 can notify participants via telephonic or other data communications techniques. As an option, instead of the administrator 901, another entity can notify participants. For example, the clearinghouse, or similar entity, discussed in the alternative for block 18 above can notify participants. As another example, an entity separate from the administrator 901 and the clearinghouse can notify participants.

After block 19, flow proceeds back to block 11, and the process begins again. The beginning of the next order period can begin immediately or with some delay. For example, if the invention is implemented for a financial exchange, two order periods may be included each day the market is open. The first order period can begin when the market opens and ends around mid-day, and the second order period begins after the notification in block 19 for the first order period and ends when the market closes. As another example, for two order periods in a day, each order period can have a duration of approximately 12 hours, where the first order period ends around noon, and the second order period ends around midnight. The length and repetition of the order period can be determined based on the needs of the marketplace and/or the participants.

In the return to block 11, the unmatched orders (e.g., the orders in FIG. 5C) are carried into the next period and become orders to be matched. Alternatively, all unmatched orders, or a subset thereof, are carried into the next period and become orders to be matched only with the consent of the participants placing the orders. As another alternative, all unmatched orders, or a subset thereof, are deleted from the marketplace before the next period begins.

### Second Embodiment

In the second embodiment, the order period of the first embodiment is removed. Instead of matching after expiration of an order period as in the first embodiment, matching occurs after each order is received. In the second embodiment, aperiodic matching is used, instead of periodic matching as in the first embodiment.

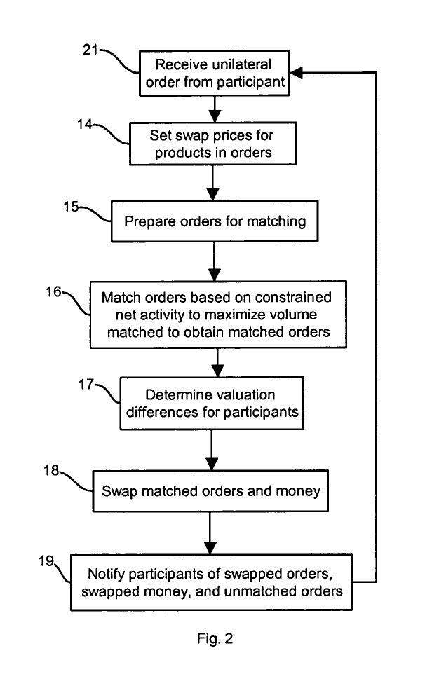

FIG. 2 illustrates a flowchart for the second embodiment of the invention. FIG. 2 is identical to FIG. 1, except for the replacement of blocks 11-13 with block 21. In block 21, the administrator 901 receives an order from a participant. Block 21 is the same as block 12, except that a single order is received, instead of a number of orders. After the single order is received, flow proceeds to block 14.

After block 19, flow proceeds back to block 21 and awaits receipt of another order. Each time an order is received, the unmatched orders from previous cycles (now to-be-matched orders) are compared with the received order.

### Third Embodiment

In the third embodiment, priorities are added to the orders received from the participants in the first embodiment. By assigning a priority to each order, the orders are prioritized for matching purposes. The administrator 901 attempts to match an order with a higher priority before matching an order with a lower priority.

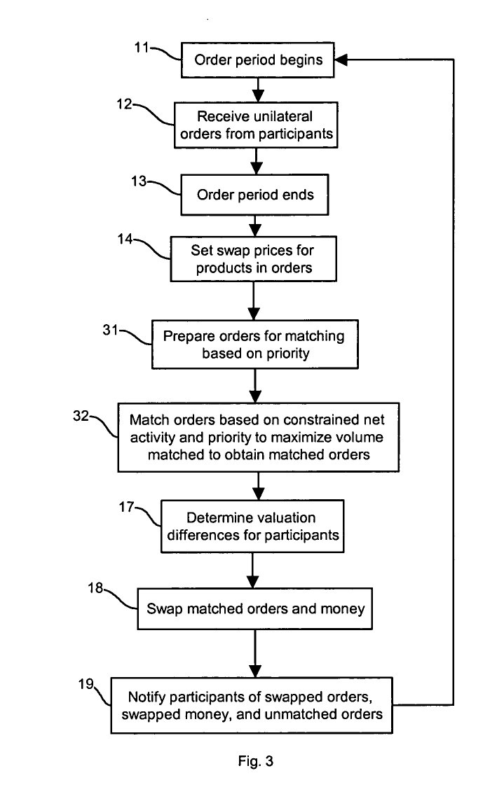

FIG. 3 illustrates a flowchart for the third embodiment of the invention. FIG. 3 is identical to FIG. 1, except for the replacement of blocks 15 and 16 with blocks 31 and 32, respectively. FIG. 3 is discussed with respect to the first example illustrated in FIGS. 5A, 5D, 5E, and 5F and with respect to FIG. 10.

In block 31, the administrator 901 prepares the received orders for matching based on priority. The administrator 901 determines the priorities of the orders. In other words, the administrator 901 ranks the orders. As an example, the administrator 901 can populate an order matrix as discussed for block 15 and can additionally populate a priority matrix. To populate the priority matrix, the administrator 901 uses the priorities assigned to each order.

Various techniques exist to prioritize the orders. For example, the orders can be prioritized based on the sequence in which the orders are received by the administrator 901. This example is known as a timing priority.

As another example, the orders can be prioritized based on the importance of the participants. For instance, participants that provide a large volume of orders to the administrator 901 can receive a higher priority, or participants who pay an additional fee receive a higher priority. This priority is known as participant priority.

As a further example, the orders can be prioritized based on the products for which orders are received. For instance, orders for a particular product may have a higher priority than orders from other products. This priority is known as product priority.

As another example, the orders can be prioritized based on the orders that were not matched in the previous order period. For instance, prior to the beginning of the next order period, the order matrix is populated with the unmatched orders, and these unmatched orders are prioritized over additional orders received during the next order period. Each participant can be considered to have “bucket” of orders forwarded to the next order period. This priority is known as unmatched order priority.

As still another example, the orders can be assigned a priority based on random selection, and this type of priority is known as random priority.

As a further example, the orders can be prioritized based on a combination of timing priority, participant priority, product priority, unmatched order priority, and/or random priority.

As an option, orders can share the same priority. With this option, however, multiple matching solutions may exist.

FIG. 5D illustrates a priority matrix for the order matrix of FIG. 5A for the first example. To populate the priority matrix, each order is ranked and assigned a priority. The priority assigned here is a random priority. Each cell 519 of the priority matrix contains the priority of the order in the corresponding cell of the order matrix of FIG. 5A. In this example, the order matrix contains 23 orders, and hence the orders are prioritized from 1 to 23. For example, the order receiving priority 1 is for participant 3 and product 1, and the order receiving priority 2 is for participant 6 and product 5.

In block 32, the administrator 901 obtains matched orders by matching orders based on constrained net activity for each participant and each product and based on the priorities of the orders from block 31 to maximize the number of orders matched independent of the swap prices. Block 32 is identical to block 16, except the priorities assigned to the orders from block 31 are used in matching the orders.

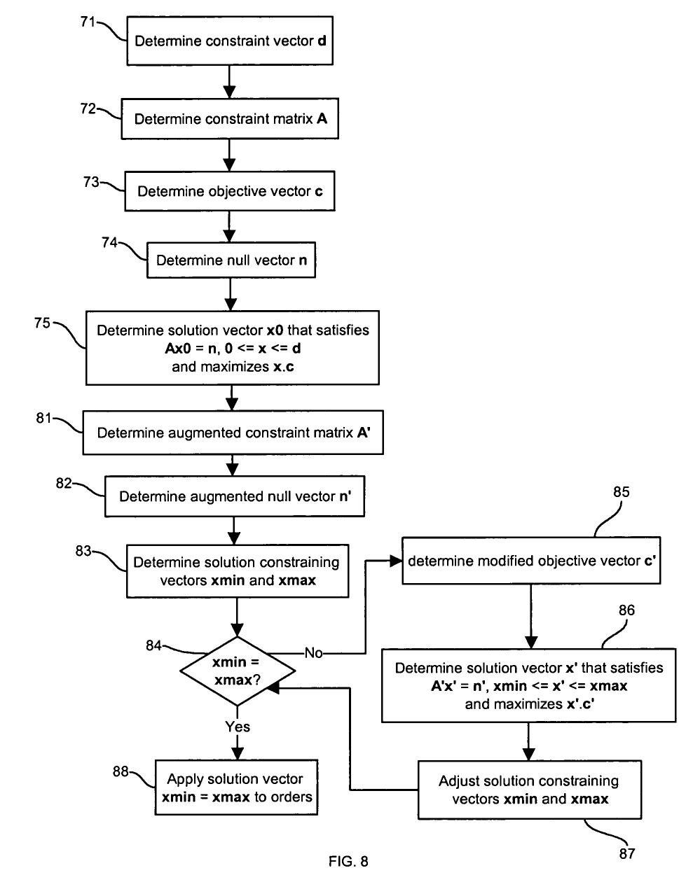

Several techniques are available to determine how to match the units desired to be sold with the units desired to be bought based on the priorities of the orders. Examples of such techniques that find an optimal solution include: linear programming; quadratic programming; linear programming to maximize a total quantity matched; quadratic (or higher-order) programming to minimize an allocation variance with a linear programming constraint to maximize a total quantity matched; an iterative linear programming to match orders having higher priority over orders having lower priority; an iterative linear programming procedure in which allocations are made in strict priority while satisfying linear programming constraints to maximize a total quantity matched; and “greedy” algorithms. One such exemplary matching is discussed below with reference to FIG. 8. Other techniques for matching units in the marketplace will be appreciated by those of ordinary skill in the technology.

FIG. 5E illustrates a matched matrix obtained by matching the orders in the order matrix of FIG. 5A based on priorities in the priority matrix of FIG. 5D. Each cell 520 in the matched matrix corresponds to the number of units matched for a corresponding participant and corresponding product in the order matrix. Each entry for a cell in the matched matrix is less than or equal the entry in corresponding cell in the order matrix. To the right of the matched matrix, column 521 provides the total number of units that to be swapped for each participant. At the bottom of the matched matrix, row 522 provides the total number of units that to be swapped for each product. At the bottom right, cell 523 provides the total number of units to be swapped due to the matching.

In comparing the matched matrices of FIGS. 5B and 5E, different orders are matched due to the priorities of the orders in the third embodiment. For example, the order for participant 3 and product 1 was not matched in FIG. 5B for the first embodiment but was matched in FIG. 5E due to a high priority (here, 1 of 23) for the third embodiment. As another example, the order for participant 1 and product 2 was matched in FIG. 5B for the first embodiment but was not matched in FIG. 5E due to a low priority (here, 18 of 23) for the third embodiment.

Further, in comparing the matched matrices of FIGS. 5B and 5E, because the same optimization goal is used (i.e., to maximize the total quantity transacted), the total number of units that can be swapped is the same, namely, 60 (compare cell 512 in FIG. 5B with cell 523 in FIG. 5E).

FIG. 5F illustrates an unmatched matrix based on the matched matrix from FIG. 5E and the order matrix of FIG. 5A. Each populated cell 524 in the unmatched matrix of FIG. 5F contains an unmatched order and is obtained by subtracting the corresponding cell in the matched matrix of FIG. 5E from the corresponding cell in the order matrix of FIG. 5A. To the right of the unmatched matrix, column 525 identifies the total number of unmatched units that each participant ordered to buy, and column 526 identifies the total number of unmatched units that each participant ordered to sell. At the bottom of the unmatched matrix, row 527 identifies the total number of unmatched units that every participant ordered to buy for each product, and row 528 identifies the total number of unmatched units that every participant ordered to sell for each product. At the bottom right, cell 529 identifies the minimum of either the total number of unmatched units that participants ordered to buy or the total number of unmatched units that participants ordered to sell.

### Fourth Embodiment

In the fourth embodiment, the order period of the third embodiment is removed, as in the second embodiment. Instead of matching after expiration of an order period as in the third embodiment, matching occurs after each order is received. In the fourth embodiment, aperiodic matching is used, instead of periodic matching as in the third embodiment.

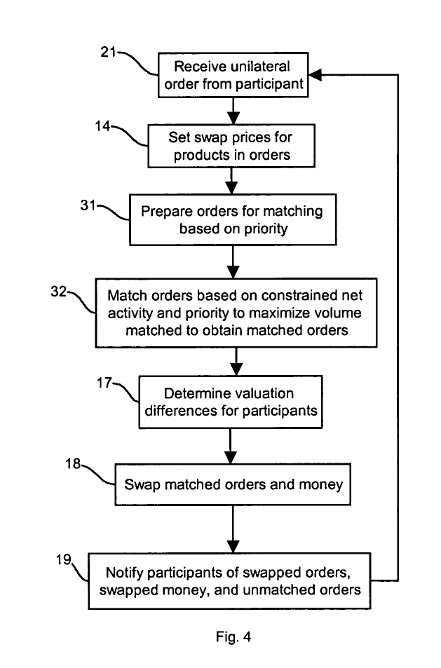

FIG. 4 illustrates a flowchart for the fourth embodiment of the invention. FIG. 4 is identical to FIG. 3, except for the replacement of blocks 11-13 with block 21. Block 21 is the same as block 21 in FIG. 2.

### Second Example

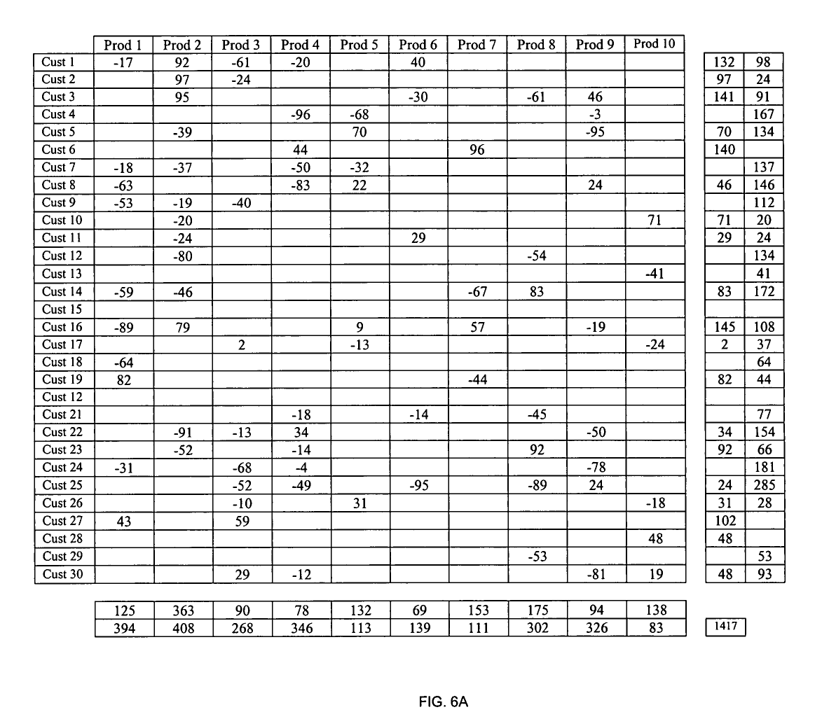

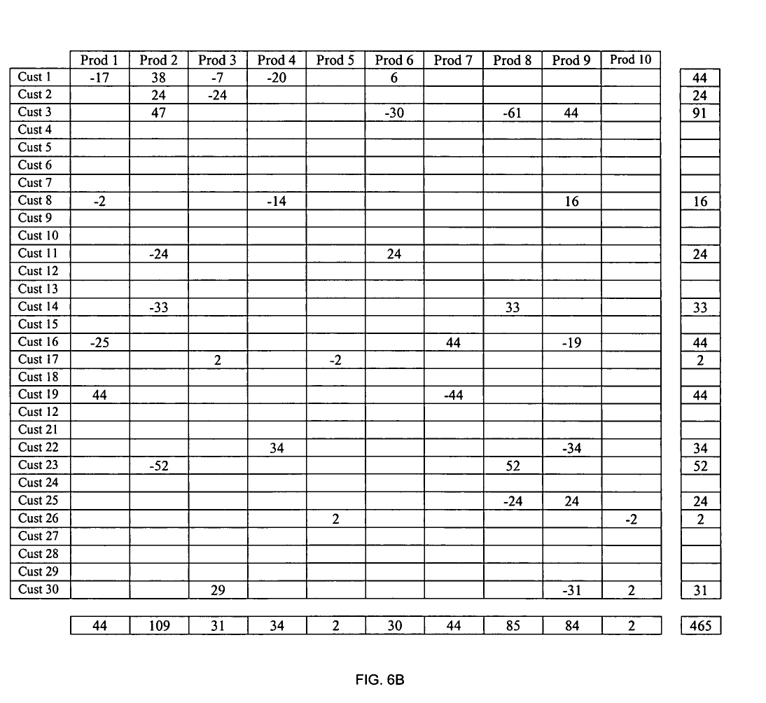

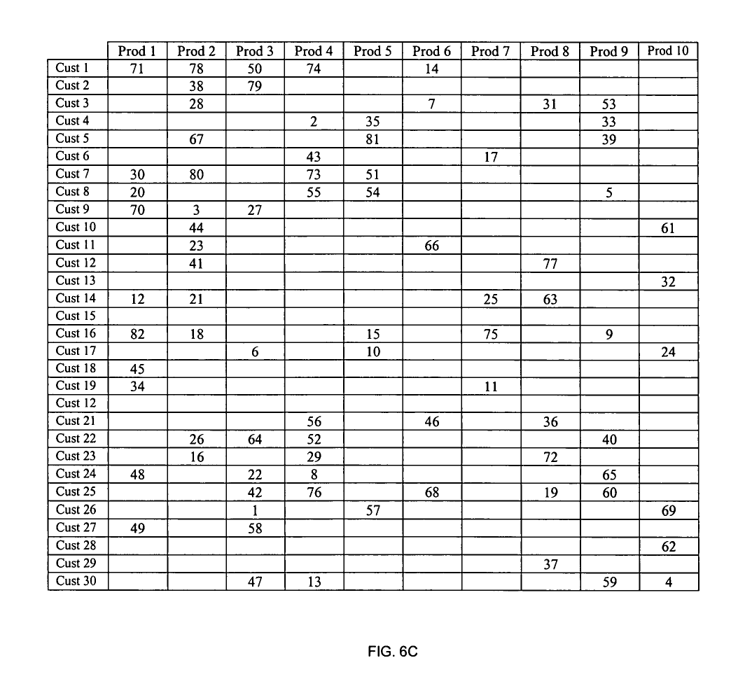

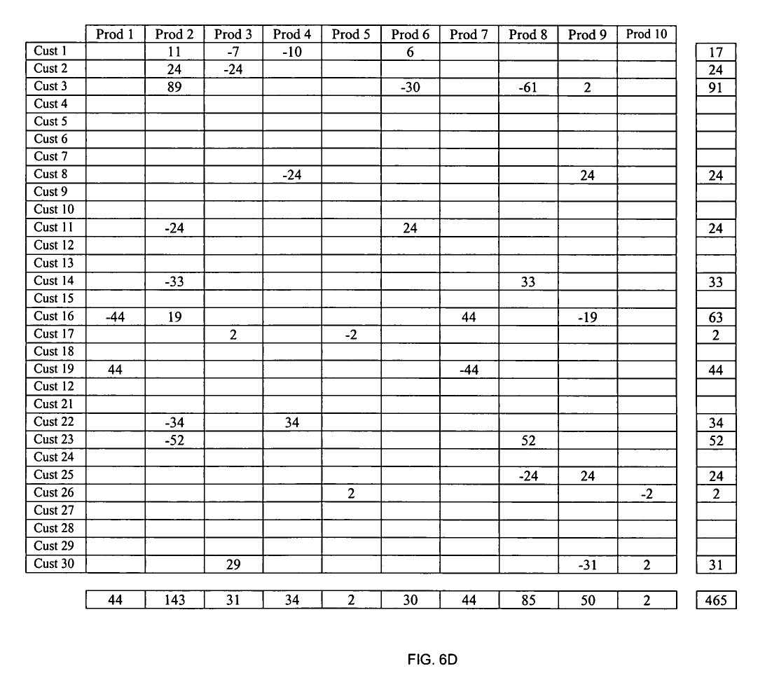

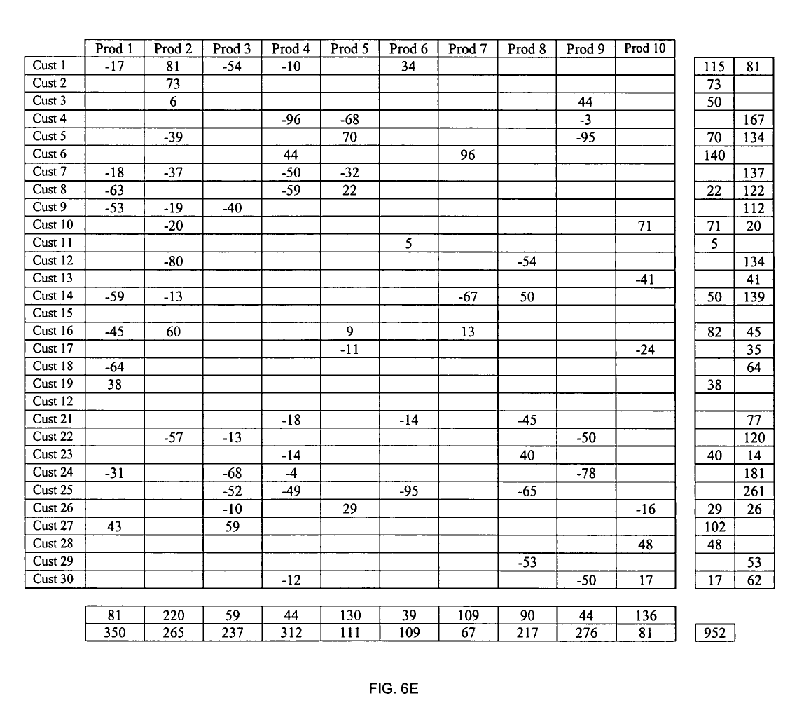

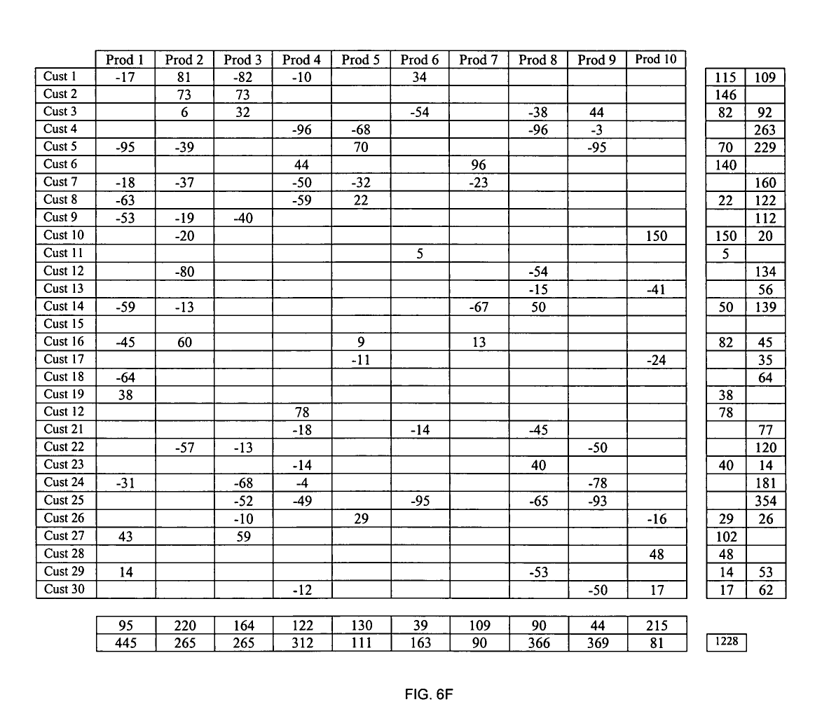

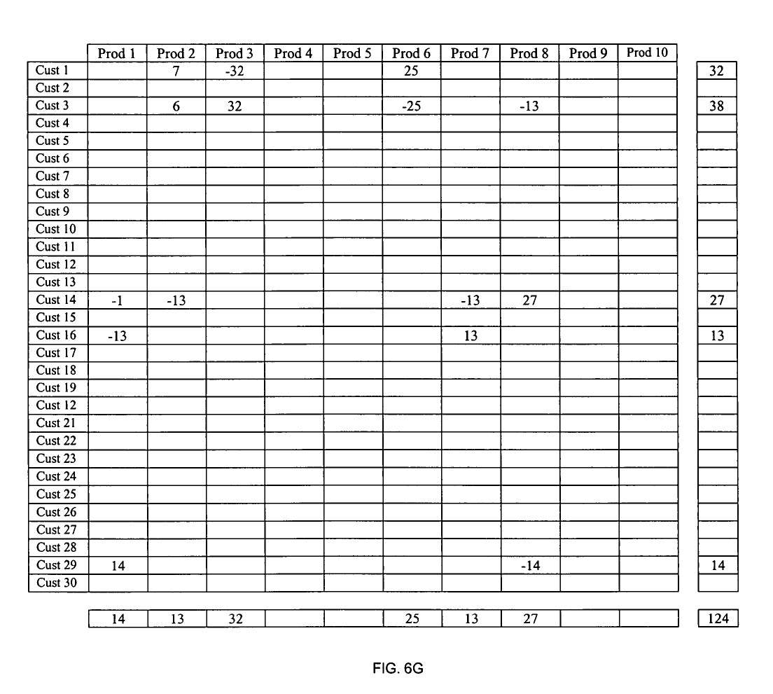

A second example for the first and third embodiments of the invention is illustrated in FIGS. 6A-6G. In the second example, 30 participants provide orders for 10 products. The same types of information for the matrices illustrated in the first example via FIGS. 5A-5F are illustrated in the second example for similar matrices.

FIGS. 6A and 6B illustrate the second example for the first embodiment. FIG. 6A depicts an order matrix for the second example for the first embodiment. FIG. 6A is similar to FIG. 5A of the first example. The order matrix is obtained after block 14 in FIG. 1.

FIG. 6B depicts a matched matrix for the second example for the first embodiment. FIG. 6B is similar to FIG. 5B of the first example. The matched matrix is obtained after block 15 in FIG. 1.

FIGS. 6A, 6C, 6D, and 6E illustrate the second example for the third embodiment of the invention. FIG. 6C depicts a priority matrix for the second example. FIG. 6C is similar to FIG. 5D of the first example. The priority matrix is obtained as per block 31 in FIG. 3 based on the order matrix in FIG. 6A. The priorities are obtained via a random priority.

FIG. 6D depicts a matched matrix based on the order matrix of FIG. 6A and the priority matrix of FIG. 6C. FIG. 6D is similar to FIG. 5E of the first example. The matched matrix is obtained as per block 32 in FIG. 3.

FIG. 6E depicts an unmatched matrix based on the order matrix of FIG. 6A and the matched matrix of FIG. 6D. FIG. 6E is similar to FIG. 5F of the first example. The matched matrix is obtained as per block 32 in FIG. 3.

FIGS. 6F and 6G illustrate looping back through the first example for the first embodiment. After the matching and swapping from FIGS. 6E and 6F, flow proceeds back to block 11. For this further example, assume flow proceeds back to block 11 in FIG. 1. A second order period is opened in block 11. Unmatched orders from the previous order period are maintained, as in the unmatched matrix in FIG. 6E. Additional orders are received by the administrator 901 in block 12. In block 13, the second order period ends. In block 14, an order matrix for the second period is populated, which is depicted in FIG. 6F. In this example, around 5% of the cells in the order matrix of FIG. 6F include additional orders from the unmatched matrix of FIG. 6E.

The order matrix in FIG. 6F includes the unmatched orders from FIG. 6E and the additional orders. In this example, for participant 1 and product 1, the unmatched order from FIG. 6E is carried over to the order matrix of FIG. 6F. As another example, for participant 2 and product 3, a new order is added to the order matrix of FIG. 6F. As a further example, for participant 10 and product 10, the unmatched order from FIG. 6E is added to in the second order period, as shown in the order matrix of FIG. 6F.

In block 15 of FIG. 1, matching of the orders in FIG. 6F occurs, and the matched matrix depicted in FIG. 6G is determined. In this example, a non-priority loop was placed after a priority loop to illustrate the various features of the invention. In practice, non-priority loops and priority loops may generally not be implemented back-to-back.

### Exemplary Matching for the First and Second Embodiments

Techniques to determine the optimum matching in block 15 of FIG. 1 are numerous, as discussed above. One such technique employs linear programming to constrain the net activity of each participant, constrain the net activity of each product, and maximize a total number of units matched independent of swap prices.

For this matching, let C be the set of participants that are eligible for or participating in the marketplace, and let M be the set of products (or markets) that are eligible for or participating in the marketplace. The number of participants in C is c, and the number of participants in M is m. Let U be the set resulting from the union of C and M (i.e., U=C∪M), which is not necessarily enumerated in a particular order, and the number of elements in U is c+m. The notation U(i) identifies the i^{th} element of U, where 1≦i≦c+m. Let O be the set of orders to be matched, and the number of orders in O is r. The notation O(i) identifies the i^{th} order in the set, where 1≦i≦r.

Five functions are used to identify the properties of the orders in the set O, namely “cust,” “mkt,” “direction,” “vol,” and “wt.” Each order is related to a participant in C and a product in M as follows:

cust:O→C (1)

mkt:O→M (2)

where “cust” is a function identifying a participant with an order, and “mkt” is a function identifying a product with an order.

Each order is identified as a buy or a sell as follows:

direction:O→{+1,−1} (3)

where “direction” is a function identifying a buy for an order as “+1” and a sell for an order as “−1”. As an option, instead of “+1” and “−1”, a number of conventions for identifying a buy and a sell can be used. For example, a convention can be used such that:

direction(order for a buy)+direction(order for a sell)=0 (4)

where direction(order for a buy)≠0, or equivalently direction(order for a buy)≠0.

An order is related to a volume, or number of units, of the order as follows:

vol:O→[0,∞) (5)

where the function “vol” can be limited to integer outputs if desired.

To generalize the technique, each product is assigned a weighting as follows:

wt:M→(−∞,∞) (6)

If no weighting is desired, the weighting is 1 for each product, and the weighting is called unitary. If non-unitary weighting is desired, not all weights are set to 1.

FIG. 7 depicts a flowchart for an exemplary matching for the first and second embodiments using the above notations. In block 71, a constraint vector d is determined. The constraint vector d is of size (r×1) and identifies the volume of each order as follows:

d(i)=vol(O(i)), for 1≦i≦r (7)

In block 72, a constraint matrix A is determined. The constraint matrix A is of size (c+m×r), where each row of A corresponds to an element of U, and each column of A corresponds to an element of O. The elements of the constraint matrix A are either +1, 0, or −1. Each element of A is determined as follows:

$$A ( i , j ) = \{ \begin{matrix}[ direction ( O ( j ) ) \times wt ( mkt ( O ( j ) ) ) ] , \\ if U ( i ) ∈ C and U ( i ) = cust ( O ( j ) ) \\ direction ( O ( j ) ) , if U ( i ) ∈ M and U ( i ) = mkt ( O ( j ) ) \\ 0 , otherwise\end{matrix} \qquad ( 8 )$$

for 1≦i≦c+m, for 1≦j≦r. The constraint matrix A is sparse. If a unitary weighting is used, the constraint matrix A is a so-called totally unimodular matrix, and the above expression is reduced as follows:

$$A ( i , j ) = \{ \begin{matrix}direction ( O ( j ) ) , if U ( i ) ∈ C and U ( i ) = cust ( O ( j ) ) \\ direction ( O ( j ) ) , if U ( i ) ∈ M and U ( i ) = mkt ( O ( j ) ) \\ 0 , otherwise\end{matrix} \qquad ( 9 )$$

for 1≦i≦c+m, for 1≦j≦r.

As an option, if the constraint matrix A is set up based on all possible products that can be exchanged in the marketplace, the efficiency of the approach can be increased by removing rows corresponding to products for which no orders exist. As another option, if the constraint matrix A is set up based on all possible participants that can exchange products in the marketplace, the efficiency of the approach can be increased by removing rows corresponding to participants without any orders.

In block 73, an objective vector c is determined. The objective vector c is of size (r×1), and each element of the objective vector c is 1. The objective vector c represents the objective of maximizing the total volume transacted without any weighting.

As an option, instead of each element of the objective vector c being 1, each element can be 1 to indicate a buy or a 0 to indicate a sell (or vice versa). With this option, instead of maximizing the number of all buys and sells, only the number of buys (or sells) is maximized, which still provides the same results.

As an option, weighting can be added by adjusting the objective vector c. Weighting can be used to prefer the matching of some products over other products. Weighting can also be used here to maximize the dollar amount transacted rather than the number of products transacted. With this option, however, whole numbers of products may not result.

In block 74, a null vector n is determined. The null vector n is of size (c+m×1), and each element of the null vector n is 0.

In block 75, a solution vector x₀ of size (r×1) is determined that satisfies

Ax₀=n (10)

0≦x₀≦d (11)

and which maximizes x₀·c. Equation (10) represents the requirement that the total sell volume allocated to each participant and to each product must equal the corresponding total buy volume allocated to each participant and to each product. In order words, the participants and products must each be so-called “flat” with respect to a total aggregate position. Equation (10) assists with constraining the net activity of each participant and each product. Maximizing x₀·c assists with maximizing a total number of units matched.

Although the swap prices can be used to weight the entries in the constant matrix A, the swap prices are not used to match units. The matching of the invention is independent of the swap prices, and any other prices.

The optimization problem for block 75 is solved using, for example, simplex-based linear programming or another optimization technique. For instance, the solution vector x₀ can be determined using a standard simplex-based linear programming software tool. In general, many solutions exists for the optimization of block 75. If the constraint matrix A is totally unimodular, all solutions returned by a simplex-based algorithm have integral values. (As an exception, ellipsoidal linear programming does not, generally, return integral results due to rounding errors, and rounding to the nearest integral solution should be used in this situation.) The solution vector x₀ describes the total matched units for each product for each participant. Due to the manner in which the optimization problem is presented, an equal number of units to sell and to buy are always matched for each participant, and an equal number of units to sell and to buy are always matched for each product.

In block 76, the solution vector x₀ is applied to the orders to obtain matched orders.

Comparing FIGS. 1, 2, and 7, blocks 71-74 in FIG. 7 are determined as part of block 15 in FIGS. 1 and 2, and blocks 75 and 76 in FIG. 7 are determined as part of block 16 in FIGS. 1 and 2.

### Exemplary Matching for the Third and Fourth Embodiments

To include priorities in the matching of orders, the exemplary matching technique for the first and second embodiments is augmented for the third and fourth embodiments. In this example, the optimization is determined by using an iterative linear programming procedure in which allocations are made in priority while satisfying linear programming constraints to maximize a number of units matched.

The same notations and definitions used for the exemplary matching technique for the first and second embodiments are used here for the third and fourth embodiments. In addition, a sixth function is used to identify an additional property of the orders in the set O, namely “priority.” The priority of the orders in the set O are identified as:

priority:O→[1, r] (12)

where the order with the highest priority has a priority of 1, and the order with the lowest priority has a priority of r.

FIG. 8 illustrates a flowchart for an exemplary matching for the third and fourth embodiments. FIG. 8 is the same as FIG. 7, except for the addition of blocks 81-87 between blocks 75 and 76.

In block 81, an augmented constraint matrix A′ is determined as follows:

$${A}^{′} = [ \begin{matrix}A \\ {c}^{T}\end{matrix} ] \qquad ( 13 )$$

The augmented constraint matrix A′ has size (c+m+1×r).

In block 82, an augmented null vector n′ is determined as follows:

$${n}^{′} = [ \begin{matrix}n \\ {x}_{0} \cdot c\end{matrix} ] \qquad ( 14 )$$

The augmented null vector n′ has size (c+m+1×1).

In block 83, minimum and maximum solution constraining vectors xₘᵢₙ and xₘₐₓ are determined as follows: xₘᵢₙ=0, and xₘₐₓ=d. The vectors xₘᵢₙ and xₘₐₓ each have size (r×1).

In block 84, the minimum and maximum solution constraining vectors xₘᵢₙ and xₘₐₓ are compared. If xₘᵢₙ and xₘₐₓ are the same, flow proceeds to block 88, where the solution vector xₘᵢₙ=xₘₐₓ is applied to the orders to obtain matched orders. Otherwise, flow proceeds to block 85.

In block 85, a modified objective vector c′ is determined. Initially, the index h of the order in the set O having the highest priority is determined such that xₘᵢₙ(h) and xₘₐₓ(h) differ. In the first pass through block 85, the index h corresponds to the order having the highest priority (i.e., priority(O(h))=1). In the second pass through block 85, the index h of this order corresponds to the order having the second highest priority (i.e., priority(O(h))=2), and so on. However, some priorities may be skipped if the corresponding entries in xₘᵢₙ and xₘₐₓ are already equal. The modified objective vector c′ is determined as follows:

$${c}^{′} ( i ) = \{ \begin{matrix}1 if i = h \\ 0 , otherwise\end{matrix} , for 1 \leq i \leq r \qquad ( 15 )$$

In block 86, a solution vector x′ of size (r×1) is determined that satisfies

A′x′=n′ (16)

xₘᵢₙ≦x′≦xₘₐₓ (17)

and which maximizes x′·c′. Equations (16) and (17) can be solved using the same techniques used to solve corresponding equations (10) and (11).

In block 87, the minimum and maximum solution constraining vectors xₘᵢₙ and xₘₐₓ are adjusted as follows: xₘᵢₙ(h)=xₘₐₓ(h)=x′·c′. Only the element in each vector xₘᵢₙ and xₘₐₓ corresponding to the order determined to have the highest priority in block 85 is adjusted. The remaining elements in the vectors xₘᵢₙ and xₘₐₓ are not adjusted. After block 87, flow proceeds back to block 84.

With the loop for blocks 84-87 in FIG. 8, the differences between the vectors xₘᵢₙ and xₘₐₓ decrease for each iteration through the loop. For each iteration of the loop, the orders are sequentially matched based on the priorities, and the vectors xₘᵢₙ and xₘₐₓ are the same along at least one additional dimension.

Comparing FIGS. 3, 4, and 8, blocks 71-74 in FIG. 8 are determined as part of block 31 in FIGS. 3 and 4, and blocks 75, 76, and 81-87 in FIG. 8 are determined as part of block 32 in FIGS. 3 and 4.

To reduce the calculation time for the loops through blocks 84-87, the linear programming tool can be so-called “hot started,” and intermittently “cold-started,” from the previous iteration through these blocks based on heuristics. With a hot start, the solution vector x′ from the previous iteration through blocks 84-87 is used as a starting point for the linear programming. A cold start may be required during the loops through blocks 84-87 if the hot-started linear programming does not converge in a predetermined number of iterations. With a cold start, the linear programming is initiated without reference to the previous solution vector x′.

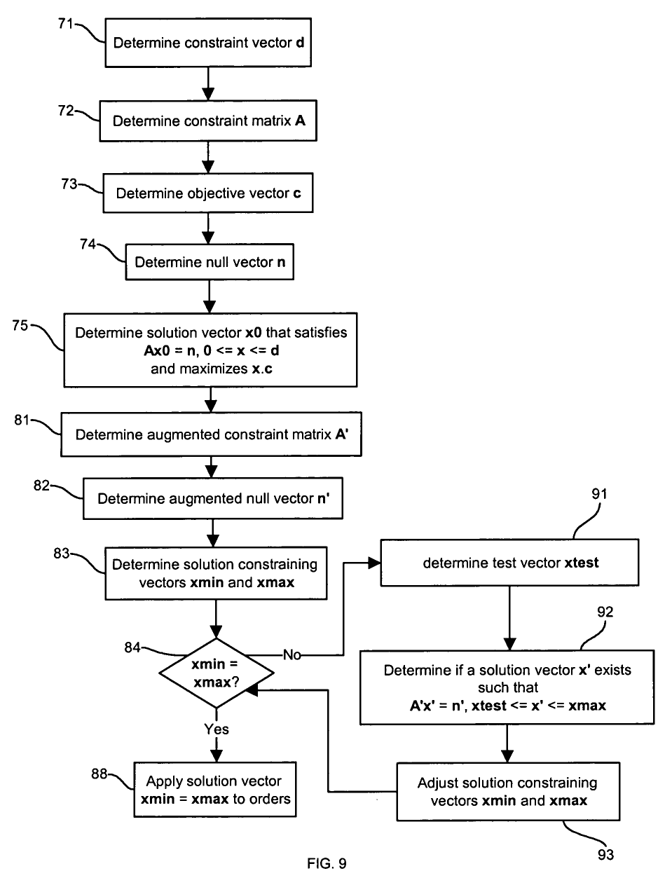

FIG. 9 depicts a flowchart for an alternative to the exemplary matching for the third and fourth embodiments illustrated in FIG. 8. FIG. 9 is the same as FIG. 8, except for the replacement of blocks 85-87 with blocks 91-93. In the alternative exemplary matching, the matching of units of products is accomplished one unit per order at a time. Although this matching can be computationally expensive, the matching provides a relatively even allocation of units between orders.

In block 91, a test vector xₜₑₛₜ of size (r×1) is determined as follows: first, let t be the index with highest priority among all indices i such that (xₘᵢₙ(i)<xₘₐₓ(i)) and further that for all indices j, (xₘᵢₙ(j)<xₘₐₓ(j)) implies (xₘᵢₙ(i)<=xₘᵢₙ(j)); and, second, define xₜₑₛₜ(t)=xₘᵢₙ(t)+1 and xₜₑₛₜ(i!=t)=xₘᵢₙ(i).

In block 92, a solution vector x′ of size (r×1) is determined that satisfies

A′x′=n′ (18)

xₜₑₛₜ≦x′≦xₘₐₓ (19)

A particular solution is not desired; instead, the inquiry is whether any solution exists that solves (18) and (19). Although no maximization is necessary, equations (18) and (19) can be solved with any convenient maximization useful for, for example, a linear programming engine. For example, equations (18) and (19) can be solved using the same techniques used to solve corresponding equations (16) and (17).

In block 93, either the minimum solution constraining vector xₘᵢₙ or the maximum solution constraining vector xₘₐₓ is adjusted based on the determination in block 92. If a feasible solution was found in block 92, xₘᵢₙ is adjusted as follows: xₘᵢₙ(t)=xₜₑₛₜ(t); if a feasible solution was not found in block 92, xₘₐₓ is adjusted as follows: xₘₐₓ(t)=xₘᵢₙ(t).

In the exemplary matching for the first, second, third, and fourth embodiments, the approaches are discussed based on the phase of each element in the constraint matrix A indicating buy or sell as appropriate (i.e., positive or negative elements). As an option, the approaches can be reformulated based on a modified constraint matrix A for block 72 having nonnegative elements as follows:

$$A ( i , j ) = \{ \begin{matrix}wt ( mkt ( O ( j ) ) ) , if U ( i ) ∈ C and U ( i ) = cust ( O ( j ) ) \\ 1 , if U ( i ) ∈ M and U ( i ) = mkt ( O ( j ) ) \\ 0 , otherwise\end{matrix} \qquad ( 20 )$$

With this option, two additional constraint vectors are used:

$$\begin{matrix}{d}_{min} ( i ) = \{ \begin{matrix}- vol ( O ( i ) ) , if direction ( O ( j ) ) < 0 \\ 0 , otherwise\end{matrix} \\ and & ( 21 ) \\ {d}_{max} ( i ) = \{ \begin{matrix}vol ( O ( i ) ) , if direction ( O ( i ) ) > 0 \\ 0 , otherwise\end{matrix} & ( 22 )\end{matrix}$$

Further, objective vector c in block 73 is changed to:

$$c ( i ) = \{ \begin{matrix}1 , direction ( O ( i ) ) > 0 \\ - 1 , otherwise\end{matrix} \qquad ( 23 )$$

In addition, for block 75, equation (11) is changed to:

dₘᵢₙ≦x₀≦dₘₐₓ (24)

Moreover, for block 83, the initial values for the minimum and maximum solution constraining vectors xₘᵢₙ and xₘₐₓ are set to dₘᵢₙ and dₘₐₓ, respectively.

With these changes for this option, the phase (i.e., the sign) of each element of the solution vector x₀ represents a buy or a sell for the respective order corresponding to the element. As an example of this notation, referring to FIGS. 5A-6F, the buys and sells are distinguished in this exemplary graphical representation based on the sign of the elements.

As an option, instead of using priorities as in the third and fourth embodiments, other goals can used for the matching. For example, the orders can be matched such that an even distribution among the participants is obtained. With this example, the solution vector x′ from above can be determined such that an even distribution among the participants is obtained. A measurement of this even distribution would be a root mean square of matched volume.

Although matrices are used in describing the orders received from the participants and the processing of the orders by the administrator 901, other types of data structures, information storage techniques, or information visualization techniques can be used to represent, store, and/or process the information. For example, graphs can be used to describe the orders.

If the invention implements a marketplace with an exchange (e.g., the Chicago Mercantile Exchange), all transactions in the exchange can be conducted with the invention. Alternatively, if a subset of all transactions in the exchange are conducted with the invention, the remaining transactions in the exchange can be conducted using one or more systems, such as an open outcry system and/or another price-competitive system.

While various embodiments of the present invention have been described above, it should be understood that they have been presented by way of example only, and not limitation. Thus, the breadth and scope of the present invention should not be limited by any of the above-described exemplary embodiments, but should instead be defined only in accordance with the following claims and their equivalents.

What is claimed is:

1. A method for matching orders comprising the steps of:
receiving a plurality of orders from a plurality of participants to buy and/or sell a plurality of products, each order being a unilateral order from one of said participants identifying a number of units of one of said products to buy or sell;
setting swap prices for said products; and
matching units of said orders based on constrained net activity for said participants and said products to maximize a number of units matched to obtain matched orders and unmatched orders, said matching independent of said swap prices.

2. A method as in claim 1, wherein said matching based on constrained net activity for said participants comprises matching units of orders such that a number of units to buy for a participant equals a number of units to sell for said participant.

3. A method as in claim 2, wherein said number of units to buy and said number of units to sell are weighted with non-unitary weightings.

4. A method as in claim 3, wherein said non-unitary weightings are based on said swap prices.

5. A method as in claim 1, wherein said matching based on constrained net activity for said products comprises matching units of orders such that a number of units to buy for a product equals a total volume of units to sell for said product.

6. A method as in claim 1, wherein said matching to maximize a volume of units matched comprises matching units of orders such that a number of units to buy and to sell is maximized.

7. A method as in claim 6, wherein said number of units to buy and to sell is weighted with non-unitary weightings.

8. A method as in claim 7, wherein said non-unitary weightings are based on said swap prices.

9. A method as in claim 1, wherein each of said unilateral orders is irrespective of a price to buy or sell.

10. A method as in claim 1, wherein at least one participant submits a plurality of unilateral orders.

11. A method as in claim 1, wherein said unilateral orders are received electronically via a network.

12. A method as in claim 1, further comprising the step of determining valuation differences for each participant based on said matched orders and said swap prices.

13. A method as in claim 12, wherein said matching to maximize a volume of units matched comprises minimizing said valuation differences.

14. A method as in claim 1, further comprising the step of notifying each participant having at least one matched order of said matched order.

15. A method as in claim 14, wherein each participant is notified electronically via a network.

16. A method as in claim 1, wherein said matching occurs after expiration of a period for receiving orders.

17. A method as in claim 16, further comprising a next period for receiving orders, said next period occurring after said matching, wherein orders for said next period include unmatched orders from said period.

18. A method as in claim 1, wherein said matching occurs after each order is received.

19. A method as in claim 1, wherein said matching uses linear programming.

20. A method as in claim 1, wherein said matching uses quadratic or higher-order programming.

21. A method as in claim 1, further comprising the step of determining a priority for each order.

22. A method as in claim 21, wherein said matching further comprises matching of units of said orders based on priorities of said orders.

23. A method as in claim 22, wherein said matching uses quadratic or higher-order programming.

24. A method as in claim 22, wherein said matching uses iterative linear programming to match orders having higher priority over orders having lower priority.

25. A method as in claim 24, wherein said matching uses heuristics to hot start or cold start iterations of said iterative linear programming.

26. A method as in claim 1, wherein said prices are determined based on at least one of current market prices, knowledge of said products, and a financial model of said products.

27. A method as in claim 1, further comprising the step of swapping said matched orders and money to obtain swapped orders and swapped money.

28. A method as in claim 1, wherein said products comprise at least one of commodities, securities, financial contracts, money, and any combination thereof.

29. A computer for performing the method of claim 1.

30. A computer-readable medium having software for performing the method of claim 1.

31. A system for matching orders comprising:
means for receiving a plurality of orders from a plurality of participants to buy and/or sell a plurality of products, each order being a unilateral order from one of said participants identifying a number of units of one of said products to buy or sell;
means for setting swap prices for said products; and
means for matching units of said orders based on constrained net activity for said participants and said products to maximize a volume of units matched to obtain matched orders and unmatched orders, said matching independent of said swap prices.

32. A system as in claim 31, wherein said means for matching further comprises matching of units of said orders based on priorities of said orders.
